(19) United States
(12) Patent Application Publication
(10) Pub. No.: US 2013/0191146 A1
(43) Pub. Date: Jul. 25, 2013

(54) APPARATUS FOR EVALUATING RADIATION THERAPY PLAN AND METHOD THEREFOR

(71) Applicant: INFINITT HEALTHCARE CO. LTD., Seoul (KR)

(72) Inventors: Jin Woo Park, Seoul (KR); Seok Woo Choi, Seoul (KR)

(73) Assignee: INFINITT HEALTHCARE CO. LTD., Seoul (KR)

(21) Appl. No.: 13/788,692

(22) Filed: Mar. 7, 2013

Related U.S. Application Data
(63) Continuation of application No. PCT/KR2010/008896, filed on Dec. 13, 2010.

(30) Foreign Application Priority Data
Sep. 17, 2010 (KR) 10-2010-0091323

(51) Int. Cl. G06F 19/00

(52) U.S. Cl. CPC G06F 19/321
USPC 705/2

(57) ABSTRACT

The present invention relates to an apparatus and to a method for comparing and evaluating therapy plan received from heterogeneous radiation therapy apparatuses. An apparatus according to an embodiment of the present invention includes a receiving means, a processing means, and a display means. The receiving means receives the patient's first radiation therapy plan data, which is generated by a first radiation therapy apparatus, and also receives the patient's second radiation therapy plan data, which is generated by a second radiation therapy apparatus. The processing means processes the first and second radiation therapy plan data to generate mixed data overlaid onto the medical image of the patient. According to a configuration of the present invention, trial and error during radiation treatment may be minimized.

### CROSS-REFERENCE TO RELATED APPLICATION

This application is a continuation of PCT/KR2010/008896 filed on Dec. 13, 2010, which claims priority to Korean Application No. 10-2010-0091323 filed on Sep. 17, 2010, which applications are incorporated herein by reference.

### TECHNICAL FIELD

The present invention relates, in general, to an apparatus for evaluating radiation therapy plan and method therefor. More particularly, the present invention relates to an apparatus for evaluating radiation therapy plan and method therefor, which can reduce discrepancies between the different radiation therapy plans obtained from different radiation therapy apparatuses (or planning appraratuses) due to dependency of a radiation therapy plan on its radiation therapy apparatus (or planning apparatus). This discrepancy of therapy plans depending on radiation therapy apparatuses (or planning apparatuses) may influence the quality and evaluation of therapy plans.

### BACKGROUND ART

Generally, radiation treatment for cancer treatment is a method of delivering a minimum radiation dose to normal tissue around cancerous tissue while delivering an optimal radiation dose to the cancerous tissue, thus improving the effects of cancer treatment without damaging the normal tissue.

In hospitals, for radiation treatment, a large number of systems or apparatuses must be used. Types of such systems and apparatuses include an Electronic Medical Record (EMR), an Order Communication System (OCS), a Picture Archiving and Communication System (PACS), a Radiation Treatment or therapy Planning System (RTP), radiation treatment equipment (e.g., a Linear Accelerator: LINAC), etc.

Among the systems and apparatuses, an RTP is a system for establishing (creating) the radiation treatment plan of a patient using programs, and is configured to establish a radiation treatment plan (or a radiation therapy plan), that is, perform the creation of radiation treatment plan information and the calculation and investigation of a radiation dose. By using such an RTP system, a user may select an optimal image from among images of a cancerous region of a patient acquired by a Computed Tomography (CT) modality or a Magnetic Resonance Imaging (MRI) modality, or may view medical pictures of the patient, personally digitize and image the pictures, perform basic image processing on resulting images, set reference coordinates for acquired images, perform contouring on each region, and calculate the direction and dose of beams in accordance with the size of cancerous tissue.

The fundamental principle of radiation treatment is intended to minimize not only acute and chronic radioreaction or complications that may occur in normal tissue, but also the occurrence of a secondary tumor, while improving the effects of cancer treatment. For this, there is a need to establish suitable radiation treatment plans.

Such radiation treatment plans are evaluated by examining other measurement values derived from dose distributions in the plans, for example, a cumulative Dose Volume Histogram (DVH), an isodose curve, the statistical values of the dose distributions, etc.

However, since radiation treatment plans depending radiation treatment planning apparatuses are different from each other, these differences may influence the quality and evaluation of treatment plans, and then there is a problem in that many trials and errors are present in proportion to such differences upon conducting radiation treatment. That is, in order to maximize the effects of treatment upon tumor treatment using high-energy radiation, optimization technology for delivering a larger amount of radiation to tumor tissue and delivering a smaller amount of radiation to normal tissue is required. However, the only solution therefor that has been presented to date is to conduct and evaluate repetitive treatment plans based on trials and errors.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been intended to solve the above-described problems. And an object of the present invention is to provide an apparatus and method that may reduce the discrepancies between radiation treatment plans depending on radiation treatment planning apparatuses and may then reduce the influence on the quality and evaluation of treatment plans.

Another object of the present invention is to provide an apparatus and method that may compare and evaluate treatment plans received from different apparatuses by performing predetermined operations on the treatment plans because, in conventional technology, data formats provided by respective radiation treatment planning apparatuses are different from each other and so operations of receiving treatment plans from different apparatuses and comparing and evaluating the treatment plans are not facilitated.

A further object of the present invention is to provide an apparatus and method that may display different radiation treatment plans on a single screen, or may set a new Region of Interest (ROI) on the screen and obtain DVH for the new ROI.

Still another object of the present invention is to implement a means that provides results at respective steps performed in this way in the form of a predetermined report form.

In order to accomplish the above objects, an apparatus for evaluating radiation treatment plan according to the present invention includes a processor. The processor further includes a reception means, a processing means, and a display means. The reception means receives a medical image of a patient created by a medical imaging apparatus (or device). The medical imaging apparatus such as CT, MRI, and ultrasonic imaging apparatus is sometimes called as “modalities”. The reception means receives first radiation treatment plan data created by a first radiation treatment apparatus for the patient and also receives second radiation treatment plan data created by a second radiation treatment apparatus for the patient. The processing means processes the first radiation treatment plan data and the second radiation treatment plan data, and generates mixed data in which processed data is overlaid on the medical image of the patient. The display means displays the mixed data generated by the processing means.

In this case, the reception means may receive the medical image of the patient, the first radiation treatment plan data, and the second radiation treatment plan data by performing direct communication over the Internet, a Local Area Network (LAN), or the like, or may import data previously stored in a storage apparatus. The term “reception”, performed by the reception means, includes all procedures, such as reception and/or acquisition based on communication, importing, data reading, etc.

Further, the reception means may receive the medical image of the patient by directly communicating with the medical imaging apparatus, or may receive it together with the first or second radiation treatment plan data via the first or second radiation treatment apparatus.

A method for evaluating radiation treatment plan according to the present invention includes a medical image reception step, a first data reception step, a second data reception step, a processing step, and a display step. At the medical image reception step, by the processor described above, a medical image of a patient is received. At the first data reception step, by the processor described above, first radiation treatment plan data about the patient is received. At the second data reception step, by the processor described above, second radiation treatment plan data about the patient is received. At the processing step, by the processor described above, the first radiation treatment plan data and the second radiation treatment plan data are processed, and then mixed data in which the processed data is overlaid on the medical image of the patient is generated. At the displaying step, by the processor described above, the mixed data generated at the processing step is displayed on a displaying unit (a monitor, TV, a beam projector, or a screen of the mobile phone/tablet, etc.).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a front view showing an apparatus for evaluating radiation treatment plan according to an embodiment of the present invention;

FIG. 2 is a diagram showing the schematic configuration of FIG. 1;

FIG. 3 is a flowchart showing a method for evaluating radiation treatment plan according to an embodiment of the present invention;

FIG. 4 is a diagram showing a screen on which final results are displayed in two dimensions; and

FIGS. 5 and 6 are diagrams showing screens on which final results are displayed in three dimensions.

### DETAILED DESCRIPTION OF THE DISCLOSURE

Hereinafter, preferred embodiments of the present invention will be described in detail with reference to the attached drawings. Reference now should be made to the components of drawings, in which the same reference numerals are used throughout the different drawings to designate the same components. In the following description, detailed descriptions of known elements or functions that may unnecessarily make the gist of the present invention obscure will be omitted.

<Description Of Apparatus>

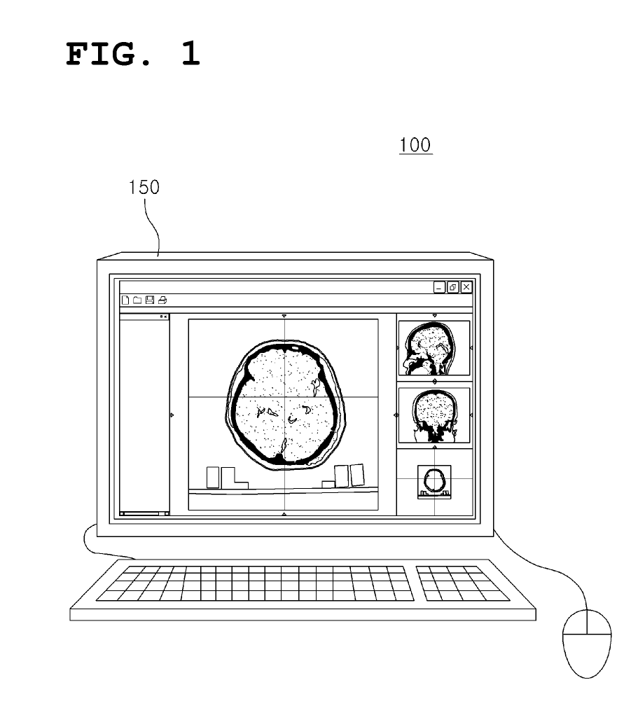

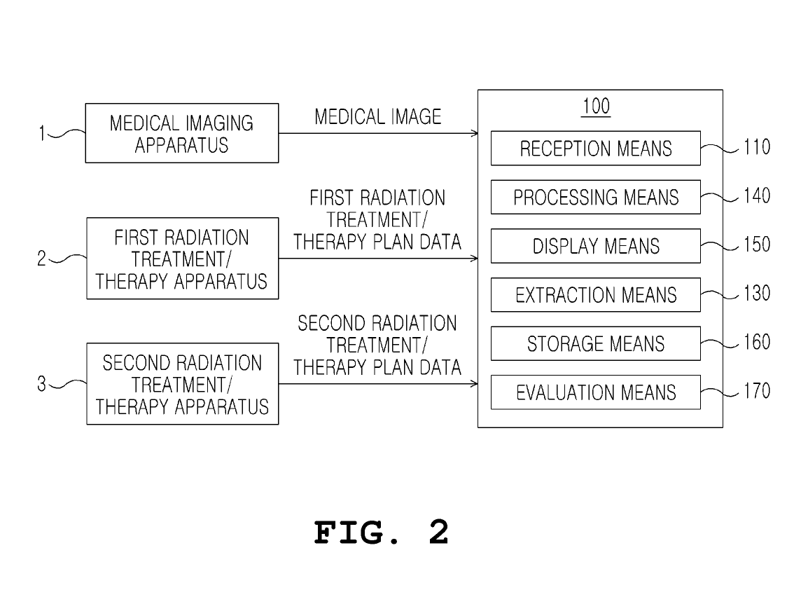

FIG. 1 is a front view showing an apparatus for evaluating radiation treatment plan according to an embodiment of the present invention, and FIG. 2 is a diagram showing the schematic configuration of FIG. 1.

Referring to FIGS. 1 and 2, an apparatus 100 for evaluating radiation treatment plan according to an embodiment of the present invention is a normal Personal Computer (PC) installed in a consulting room or a ward, and includes a processor. The processor further includes a reception means 110, an extraction means 130, a processing means 140, a display means 150, a storage means 160, and an evaluation means 170.

The reception means 110 receives a medical image of a patient created by a medical imaging apparatus 1, such as a Computed Tomography (CT) modality, a Magnetic Resonance Imaging (MRI) modality, an endoscope, or ultrasonic modality. In this case, the transmission of the medical image created by the medical imaging apparatus 1 complies with Digital Imaging and Communication in Medicine (DICOM) standards, and an old-fashioned medical apparatus that does not support DICOM may be equipped with an additional apparatus (not shown) functioning to convert a medical image into digital information.

The reception means 110 receives first radiation treatment plan (or Radiation Therapy Plan: RTP) data about the patient created by a first radiation treatment apparatus 2, and second radiation treatment plan data about the patient created by a second radiation treatment apparatus 3. Here, the first and second radiation treatment apparatuses 2 and 3 are different apparatuses, and may be implemented as teleradiotherapy systems which externally deliver radiation, such as low-energy x-ray therapy equipment, a Cobalt-60 teletherapy unit, a linear accelerator, or a particle accelerator, or brachytherapy apparatuses which conduct treatment by injecting a radiation source into the body of the patient. As described above, the first and second radiation treatment apparatuses 2 and 3 are apparatuses having different characteristics, so the first and second radiation treatment plan data may be different from each other. The first and second radiation treatment plan data may include information about a plan to minimize a radiation dose delivered to healthy tissue around a tumor while exactly and uniformly delivering an optimal radiation dose to the tumor by maximally adjusting radiation type, radiation plan images, radiation intensity, the direction and plane of radiation delivery, multi-irradiation, etc. Further, the first and second radiation treatment plan data include information used to implement the distribution of radiation into a human body in two dimensions or three dimensions, check whether the ideal distribution of radiation dose has been implemented on a screen, and plan radiation treatment.

The reception means 110 may receive the medical image data, the first radiation treatment plan data, and the second radiation treatment plan data while directly communicating with the corresponding apparatuses, or may import previously-stored data. Further, the medical image data may be directly received from the medical imaging apparatus, or may be received via the first radiation treatment apparatus or the second radiation treatment apparatus.

The extraction means 130 extracts predetermined parameters from the first radiation treatment plan data and the second radiation treatment plan data so that mixed data may be generated by the processing means 140. The predetermined parameters in the present invention denote parameters required to plan exact doses and obtain optimal radiation delivery so that radiation may be concentrated only on a tumor region, as in the case of a radiation Dose-Volume Histogram (DVH).

A radiation dose is calculated in correspondence with each voxel, and a dose distribution may be known from the radiation dose. Representative values, such as DVH, may summarize and indicate the dose distribution.

The processing means 140 functions to process the first radiation treatment plan data and the second radiation treatment plan data and generate mixed data in which the processed data is overlaid on the medical image of the patient, and is configured to perform predetermined operations on the predetermined parameters extracted by the extraction means 130. The predetermined operations include one or more of addition, subtraction, and merging operations, and the processing means 140 generates the mixed data by performing the several operations. Generally, radiation treatment plans are different from each other between respective apparatuses and may then influence the quality and evaluation of the treatment plans. However, the present invention extracts predetermined parameters from the first and second radiation treatment plan data received from the first and second different radiation treatment apparatuses 2 and 3, and generates mixed data in which the parameters are overlaid on the medical image of the patient, thus providing a reliable optimal radiation treatment plan. In accordance with this provision, trials and errors that may occur in radiation treatment are minimized, and so the quality of the treatment plan may be maximized.

As one embodiment, mixed data provided by the processing means 140 may be mixed data displayed by allocating separate plans to respective colors. For example, first radiation treatment plan data may be allocated to red, and second radiation treatment plan data may be allocated to blue. Further, the displayed mixed data may indicate dose distributions of a first radiation treatment plan and a second radiation treatment plan by the sizes or densities of red and blue voxels (or points corresponding to the voxels). The user may select the most suitable radiation treatment plan by comparing the dose distributions of the radiation treatment plans using the displayed mixed data.

As another embodiment modified from the above embodiment, a method of displaying a radiation treatment plan which provides the maximum value of the doses of the respective voxels in color may also be implemented. That is, when, of the doses of voxel V, a dose corresponding to the first radiation treatment plan is greater than a dose corresponding to the second radiation treatment plan, voxel V may be displayed in red. In contrast, when, of the doses of voxel V, a dose corresponding to the first radiation treatment plan is less than a dose corresponding to the second radiation treatment plan, voxel V may be displayed in blue. When, of the doses of voxel V, a dose corresponding to the first radiation treatment plan is identical to a dose corresponding to the second radiation treatment plan, voxel V may be displayed in violet which is a mixed color of red and blue.

Even when the number of radiation treatment plans desired to be compared is three or more, colors are allocated to respective treatment plans, and the color of a treatment plan which provides the maximum value of the doses of each voxel may be displayed as a representative value of the corresponding voxel. If doses of two or more treatment plans simultaneously form a maximum value, a mixed color of the colors corresponding to the two or more treatment plans may be displayed as a representative value of the corresponding voxel.

As a further embodiment of mixed data, a method of generating mixed data from a difference between doses of a first radiation treatment plan and a second radiation treatment plan may also be implemented. For example, in a case where, if a dose corresponding to the first radiation treatment plan for a specific voxel is greater than a dose corresponding to the second radiation treatment plan, the voxel is displayed in blue, whereas if a dose corresponding to the first radiation treatment plan is less than a dose corresponding to the second radiation treatment plan, the voxel is displayed in red, a user may determine which one of the doses corresponding to the radiation treatment plans is suitable for the purpose of treatment, based on the ratio of red to blue.

The display means 150 displays the mixed data generated by the processing means 140, and provides a report form in which results obtained by one or more of the reception means 110 and the processing means 140 can be recorded. As described above, the report form is separately provided, so that when there is a need to record results obtained by the respective components, that is, contents at respective steps, they may be conveniently recorded, and the recorded contents may be promptly recognized.

In order to display the first radiation treatment plan data, the second radiation treatment plan data, and the mixed data on the display means 150, the storage means 160 defines and stores parameter sets. Such parameter sets are configured to display first and second different radiation treatment plan data and the mixed data in various manners, so that operations, such as addition, subtraction or merging operations, may be performed on first and second different radiation treatment plan data, and the resulting value of mixed data may be quantitatively provided. The parameter sets may be defined as resulting values of various types of operations on the different radiation treatment plan data, and may also be given as corresponding relationships between the resulting values of operations and colors to be displayed, or representation techniques.

The evaluation means 170 evaluates one or more radiation treatment plans (or Radiation Therapy Plans: RTPs) based on a predetermined valuation basis, by using the parameter of the resulting value of the mixed data quantitatively provided by the processing means 140. The predetermined valuation basis in the present invention may be either the ratio of radiation doses allowable to be applied to respective organs of a patient to radiation doses actually applied to the respective organs, or information about whether an actually applied dose exceeds an allowable dose.

In this case, in order to precisely predict the distribution of radiation dose delivered to a patient when the patient undergoes radiation treatment, it is preferable to use a three-dimensional (3D) patient model. Upon conducting actual evaluation, the distribution of radiation dose is calculated per volume pixel (voxel: each 3D pixel constituting a 3D image), and some of various statistical values, such as a mean value, an intermediate value, a maximum value, a standard deviation, and a deviation, may be selected and evaluated.

Alternatively, the ratio of the number of voxels for which an actually applied dose exceeds an allowable dose to the total number of voxels may be a valuation basis.

Further, by displaying results obtained based on a position at which targets conflict with each other, the user may readjust a current radiation treatment plan to a radiation treatment plan having an optimal dose distribution. Furthermore, since the effectiveness of the radiation treatment plan may be determined based on the above valuation basis, radiation treatment may be efficiently conducted, and the quality of radiation treatment may be maximized.

Meanwhile, the processing means 140 provides menus so that a new Region of Interest (ROI) may be set on the screen of the display means 150, and calculates new mixed data for the new ROI if the new ROI has been set. In this case, the new mixed data includes the distribution of radiation dose applied to a patient with respect to the new ROI. When a new ROI is detected after a radiation treatment plan has been established, an ROI is newly generated, and a radiation dose for the corresponding ROI may be obtained from a radiation dose map. By means of this radiation dose, a radiation dose-volume histogram may be created. As described above, since the modification and alteration of the radiation treatment plan are facilitated, the satisfaction of the user may be improved. In the present invention, it is preferable to provide various types of information and convenience in to such a way that resulting data, such as radiation treatment plans, may be transmitted to other systems, such as a Picture Archiving and Communication System (PACS), an Electronic Medical Record (EMR), or an Order Communication System (OCS), over a network, and then the same data may be inquired about in real time even in different places.

<Description of Method>

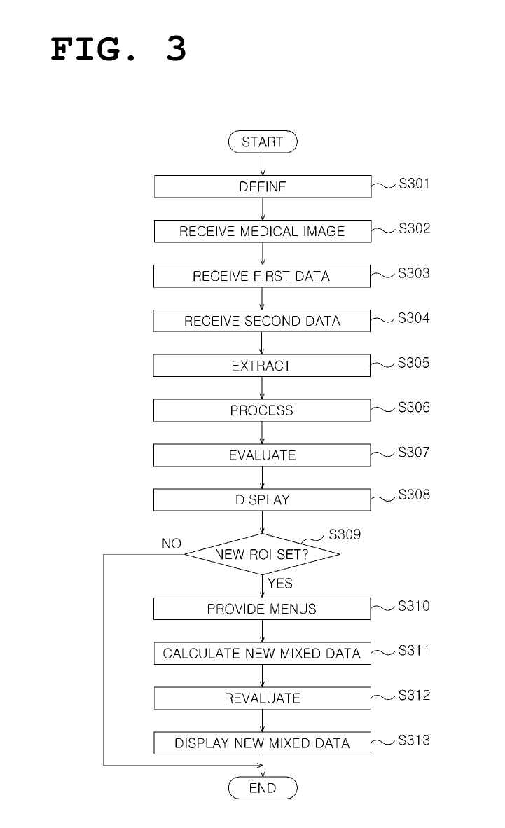

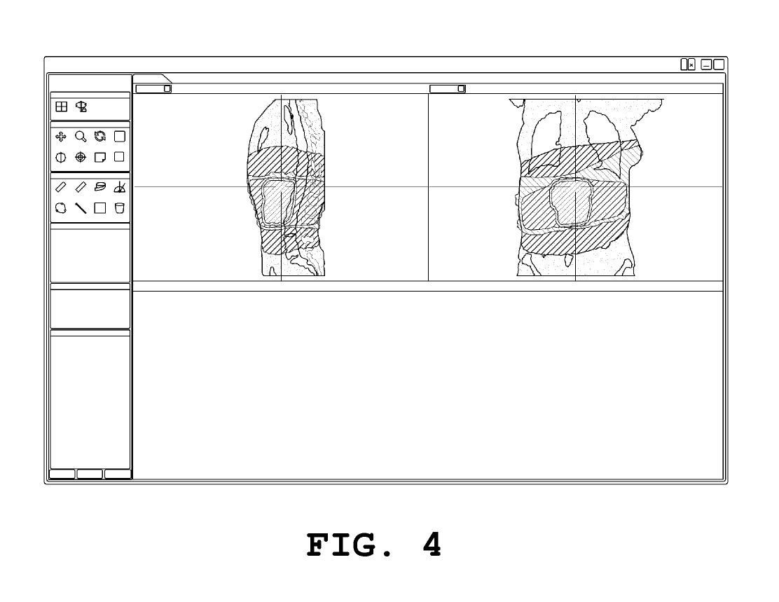

A method for evaluating radiation treatment plan according to an embodiment of the present invention will be described with reference to exemplary drawings shown in FIGS. 4 to 6, together with a flowchart shown in FIG. 3, wherein for the convenience of description, respective operations are numbered. The method for evaluating radiation treatment plan may be executed by a processor included in the apparatus for evaluating radiation treatment plan according to an embodiment of the present invention.

1. Definition Step <S301>

In order to display the different first and second radiation treatment plan data and mixed data in various manners, parameter sets are pre-defined and stored by the processor described above.

2. Medical Image Reception Step <S302>

At a reception step S302, a medical image of a patient is received.

The medical image of the patient may be received from the medical imaging apparatus 1 over a network. Alternatively, a procedure for loading or importing previously stored medical images may also be implemented as an embodiment of step S302. Further, the medical image data may be received via the first radiation treatment apparatus 2 or the second radiation treatment apparatus 3 by the processor described above.

3. First Data Reception Step <S303>

First radiation treatment plan data about the patient is received from the first radiation treatment apparatus 2 by the processor described above. In this case, similar to medical image reception step S302, reception step S303 may include a procedure for receiving the first radiation treatment plan data over the network or a procedure for loading or importing previously stored first radiation treatment plan data as one embodiment.

4. Second Data Reception Step <S304>

Second radiation treatment plan data about the patient is received from the second radiation treatment apparatus 3 by the processor described above. Here, the first and second radiation treatment apparatuses 2 and 3 may be different apparatuses, and so first and second radiation treatment plan data may be created as different types of data.

5. Extraction Step <S305>

In this step, the processor described above extracts predetermined parameters from the first radiation treatment plan data and the second radiation treatment plan data so that mixed data may be generated at the following step S306, wherein the predetermined parameters denote parameters required to plan an exact dose and obtain an optimal radiation dose so that radiation may be concentrated only on a tumor region.

6. Processing Step <S306>

The first radiation treatment plan data and the second radiation treatment plan data are processed by the processor described above, and then mixed data in which the processed data is overlaid on the medical image of the patient is generated. At this step, predetermined operations are performed on the predetermined parameters extracted at step S305, and the predetermined operations include one or more of addition, subtraction and merging operations and also quantitatively provide to the resulting value of the mixed data. As described above, the predetermined parameters are extracted from the respective first and second radiation treatment plan data received from the first and second different radiation treatment apparatuses 2 and 3, and then mixed data in which the parameters are overlaid on the medical image of the patient is generated, thus enabling a reliable optimal radiation treatment plan to be provided. According to this provision, trials and errors that may occur in radiation treatment may be minimized, and thus the quality of the treatment plan may be maximized.

7. Evaluation Step <S307>

In this step, the processor described above evaluates one or more radiation treatment plans (or Radiation Therapy Plans: RTPs) based on a predetermined valuation basis by using the parameter of the quantitatively provided resulting value of the mixed data, and the predetermined valuation basis may be the ratio of radiation doses allowable to be applied to respective organs of a patient to radiation doses actually applied to the respective organs. Alternatively, the valuation basis may be information about whether an actually applied radiation dose exceeds an allowable radiation dose.

8. Display Step <S308>

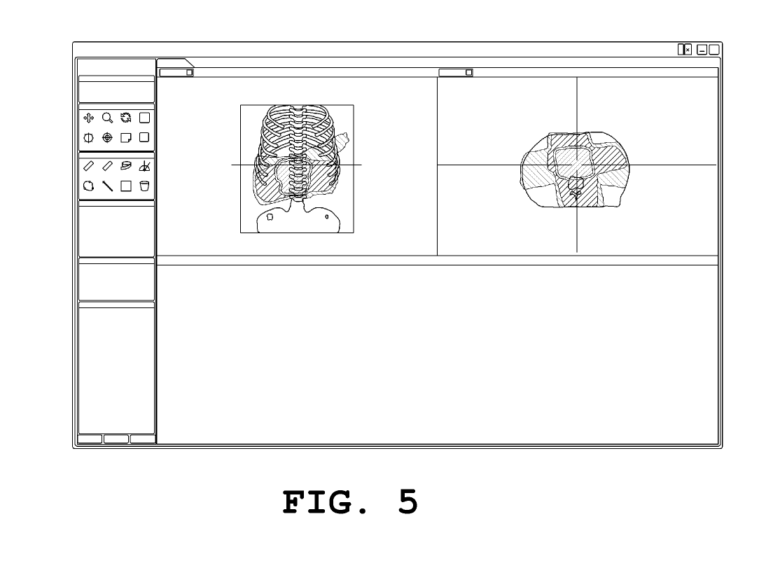

Final results obtained by evaluating the mixed data, generated at step S306, at step S307, are displayed by the processor described above on a displaying unit (such as a monitor, a TV, a beam projector, etc.). That is, as shown in FIG. 4, a shape in which cancerous tissue receives radiation is displayed in two dimensions at the center of a screen, and degrees in which individual regions of a body receive energy from three X-ray beams are displayed as color distributions. Further, as shown in FIG. 5, the distribution of energy received from X-rays is displayed in three dimensions. A user may adjust a radiation treatment plan in consideration of prescriptions for a patient related to a target desired to be obtained by the user, for example, the size of a tumor that is to be removed and the size of other healthy tissues that are not to be damaged, by referring to the energy distribution displayed in three dimensions.

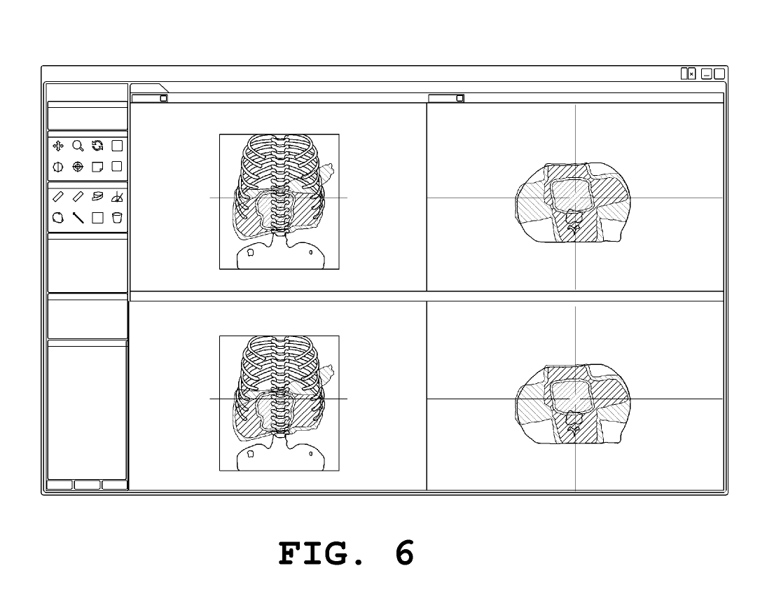

In this case, in FIG. 4, radiation distribution formed by the radiation treatment plan is shown in a sagittal plane and a coronal plane. In FIG. 5, the radiation distribution is modeled and viewed in three dimensions, whereas radiation distribution projected on an axial plane is shown. Further, in FIG. 6, the results of evaluation of the radiation treatment plans performed at the above evaluation step S307 are shown.

9. New Region of Interest (ROI) Setting Inquiry Step <S309>

This step is configured to inquire of the user whether to set a new ROI so that a new ROI can be set on the screen displayed at step S308. This step is intended to facilitate the modification and alteration of radiation treatment plans.

10. Menu Provision Step <S310>

Menus are provided to the user so that a new ROI may be set on the displayed screen in response to the setting request for the inquiry at step S309. Accordingly, the user performs an operation of drawing an ROI, which is represented by a set of closed curves.

11. New Mixed Data Calculation Step <S311>

In this step, the processor described above calculates new mixed data for the new ROI set using the menus at step S310, wherein the new mixed data includes the distribution of radiation dose applied to the patient, with respect to the new ROI, and the resulting value of the new mixed data is also quantitatively provided. This step may be performed in the same manner as that of steps S306 and S307.

12. Revaluation Step <S312>

In this step, the processor described above evaluates one or more new radiation treatment plans based on the predetermined valuation basis by using the parameter of the resulting value of the new mixed data quantitatively provided at step S311, and the treatment plans may be evaluated in the same manner as that of the above-described step S307.

13. New Mixed Data Display Step <S313>

New final results obtained by evaluating the new mixed data, calculated at step S311, at step S312 are displayed on the screen.

Meanwhile, a report form in which the results of one or more of the steps S301 to S313 may be recorded is provided, so that a report may be created according to the user's selection.

The method for evaluating radiation treatment plan according to embodiments of the present invention may be implemented in the form of program instructions that are executable by various types of computer means, and may be recorded in a computer-readable storage medium. The computer-readable storage medium may include program instructions, data files, and data structures either independently or in combination. The program instructions stored in the medium may be designed and configured especially for the present invention or may be known to and usable by those skilled in the art of computer software. Examples of the computer-readable storage medium may include a magnetic medium such as a hard disk, a floppy disk, or magnetic tape, an optical medium such as Compact Disk-Read Only Memory (CD-ROM) or a Digital Versatile Disk (DVD), a magneto-optical medium such as a floptical disk, and a hardware apparatus such as ROM, Random Access Memory (RAM), or flash memory which is especially configured to store and execute program instructions. Examples of the program instructions include not only such machine language code as created by a compiler, but also such high-level language code as being executable by a computer using an interpreter or the like. The hardware apparatus can be configured to function as one or more software modules so as to perform the operation of the present invention, and vice versa.

The above description has been made merely to exemplarily describe the technical spirit of the present invention, and those skilled in the art to which the present invention pertains will appreciate that various changes and modifications are possible, without departing from the essential features of the invention. Therefore, the embodiments disclosed in the present invention are intended to describe the technical spirit of the present invention rather than to restrict the technical spirit thereof, and the scope of the technical spirit of the present invention is not limited by these embodiments. The scope of the present invention should be defined by the accompanying claims, and all technical spirits within an equivalent scope of the claims should be interpreted as being included in the scope of the present invention.

As described above, in accordance with the present invention, the following advantages are obtained.

First, the present invention extracts predetermined parameters from first and second radiation treatment plan data received from first and second different radiation treatment apparatuses and generates mixed data in which the parameters are overlaid on a medical image of a patient, thus providing a reliable optimal radiation treatment plan. In accordance with this provision, trials and errors that may occur in radiation treatment are minimized, and thus the quality of a treatment plan may be maximized.

Second, the present invention provides menus so that a new Region of Interest (ROI) can be set on a screen, and calculates new mixed data for a new ROI if the new ROI has been set, and so the modification and alteration of a radiation treatment plan are facilitated, thus improving a user's satisfaction.

Third, a separate report form is provided, so that if there is a need to record results obtained by respective components, that is, contents at respective steps, the results may be conveniently recorded, and the recorded contents may be promptly recognized.

The present invention relates to an apparatus and method that are capable of comparing and evaluating treatment plans received from different radiation treatment apparatuses.

What is claimed is:

1. An apparatus for evaluating radiation therapy plan, comprising:
a processor configured to:
receive a medical image of a patient captured by a medical imaging device, first radiation therapy plan data created by a first radiation therapy apparatus for the patient, and second radiation therapy plan data created by a second radiation therapy apparatus for the patient;
process the first radiation therapy plan data and the second radiation therapy plan data, to generate mixed data;
overlap the mixed data on the medical image of the patient; and
display the generated mixed data.

2. The apparatus of claim 1, wherein the processor is further configured to:
extract predetermined parameters from the first radiation therapy plan data and the second radiation therapy plan data; and
perform one or more of addition, subtraction, and merging operations to the predetermined parameters to generate the mixed data.

3. The apparatus of claim 1, wherein the processor is further configured to:
store and define parameter sets to display the first radiation therapy plan data, the second radiation therapy plan data, and the mixed data on a display.

4. The apparatus of claim 1, wherein the processor is further configured to:
provide a resulting value of the mixed data, and
evaluate one or more radiation therapy plans based on a predetermined valuation basis using a parameter of the provided resulting value of the mixed data.

5. The apparatus of claim 4, wherein the predetermined valuation basis is a ratio of radiation doses allowable to be applied to respective organs of the patient and radiation doses actually applied to the respective organs.

6. A method of evaluating a radiation therapy plan, comprising:
receiving, at a processor, a first radiation therapy plan data for a patient;
receiving, at the processor, a second radiation therapy plan data for the patient;
receiving, at the processor, a medical image of the patient;
processing, by the processor, the first radiation therapy plan data and the second radiation therapy plan data, to generate mixed data;
overlapping, by the processor, the mixed data on the medical image of the patient; and
displaying, by the processor, the generated mixed data.

7. The method of claim 6, further comprising:
extracting, by the processor, predetermined parameters from the first radiation therapy plan data and the second radiation therapy plan data; and
the processing further includes performing, by the processor, one or more of addition, subtraction, and merging operations to the predetermined parameters to generate the mixed data.

8. The method of claim 6, further comprising:
storing and defining, by the processor, parameter sets to display the first radiation therapy plan data, the second radiation therapy plan data, and the mixed data.

9. The method of claim 6, wherein the processing further includes:
quantitatively providing, by the processor, a resulting value of the mixed data, and
evaluating, by the processor, one or more radiation therapy plans based on a predetermined valuation basis using a parameter of the quantitatively provided resulting value of the mixed data.

10. The method of claim 9, wherein the predetermined valuation basis is a ratio of radiation doses allowable to be applied to respective organs of the patient and radiation doses actually applied to the respective organs.

11. A non-transitory computer readable medium containing executable program instructions executed by a processor that stores a program for executing a method of evaluating a radiation therapy plan, comprising:
program instructions that receive a first radiation therapy plan data for a patient;
program instructions that receive a second radiation therapy plan data for the patient;
program instructions that receive a medical image of the patient;
program instructions that process the first radiation therapy plan data and the second radiation therapy plan data, to generate mixed data in which processed data is overlaid on the medical image of the patient; and
program instructions that display the generated mixed data.

12. The non-transitory computer readable medium of claim 11, further comprising:
program instructions that extract predetermined parameters from the first radiation therapy plan data and the second radiation therapy plan data to generate the mixed data.

13. The non-transitory computer readable medium of claim 12, further comprising:
program instructions that store and define parameter sets to display the first radiation therapy plan data, the second radiation therapy plan data, and the mixed data.

14. The non-transitory computer readable medium of claim 12, further comprising:
program instructions that quantitatively provide a resulting value of the mixed data, and
program instructions that evaluate one or more radiation therapy plans based on a predetermined valuation basis using a parameter of the quantitatively provided resulting value of the mixed data.

15. The non-transitory computer readable medium of claim 14, wherein the predetermined valuation basis is a ratio of radiation doses allowable to be applied to respective organs of the patient and radiation doses actually applied to the respective organs.
